(19) United States
(12) Patent Application Publication
(10) Pub. No.: US 2010/0108650 A1
(43) Pub. Date: May 6, 2010

(54) Automatic Positioning/Engraving Method For A Laser Engraving Machine

(76) Inventors: Hans HUANG, Taipei Hsien (TW); Yao-Fang Lee, Taipei Hsien (TW); William Chai, Taipei Hsien (TW)

Correspondence Address: IPFortune LLC, 1629 K Street N.W., Suite 300, Washington, DC, 20006, US

(21) Appl. No.: 12/263,439

(22) Filed: Oct. 31, 2008

(51) Int. Cl. B23K 26/00

(52) U.S. Cl. 219/121.69

(57) ABSTRACT

An automatic positioning/engraving method for a laser engraving machine is provided. A pen carriage of the laser engraving machine is moved above a provided workpiece. Before engraving, at least two positioning points on the peripheries of the workpiece are first positioned. A processor is used to calculate and determine a center for the positioning points. Finally, a driving unit is utilized to move the pen carriage to the center point and begin pattern engraving or cutting operation.

### TECHNICAL FIELD

The present invention is related to a laser engraving method for a laser engraving machine and, more particular, to an automatic positioning/engraving method for a laser engraving machine, where at least two positioning points are positioned on the peripheries of a workpiece, a processor is then provided to calculate and decide a center between the two positioning points, and, finally, a driving unit is used to move a pen carriage to the center to start pattern engraving or cutting operation.

### BACKGROUND

The process for laser engraving or cutting is very simple. Like printing a paper via a computer and a printer, patterns can be engraved onto a workpiece by using a laser engraving machine. The only difference is that printing is to apply ink onto a paper while laser engraving is to project laser onto a wooden article, an acryl, a plastic plate, a metallic plate or a stone and the engraving procedure can be easily completed.

It is a conventional way to position a workpiece on a working platform before a laser engraving process. Thereafter, the center of a pattern to be processed is obtained by means of measurement with a ruler. The pen carriage of a laser engraving system is then manually moved to the center of the workpiece. When the center of the pattern is also projected onto the workpiece, the position of the pattern to be engraved on the workpiece is determined.

Accordingly, a center is usually determined by means of measurement with a ruler on the workpiece or is roughly determined by visual estimation conventionally. By this way, deviation of the center resulted from such manual positioning is inevitable and it takes more time for manual positioning. In order to overcome these disadvantages, the present invention provides an automatic positioning/engraving method for a laser engraving machine after many years study, hard research, and developments.

### SUMMARY OF THE DISCLOSURE

The primary object of the present invention is to provide an automatic positioning/engraving method for a laser engraving machine. The technical features of the present invention are: setting at least two positioning points on the peripheries of a workpiece; determining a center between the two positioning points by the calculation of a processor; automatically moving a pen carriage to the center to start pattern engraving or cutting. Thereby, when a pattern is accurately formed on a workpiece by using the method according to the present invention, it saves time without manual positioning and prevents errors resulted from manual positioning.

To achieve the above objectives, the present invention provides an automatic positioning/engraving method for a laser engraving or cutting machine comprising following steps: A. providing a workpiece; B. moving a pen carriage of the laser engraving machine to position at least two positioning points on the peripheries of the workpiece; C. providing a processor to calculate and decide a center between the two positioning points; and D. utilizing a driving unit to move the pen carriage to the center and begin pattern engraving or cutting.

In practice, in step B, a first positioning point and a second positioning point are preferably setup and a center between the first and second positioning points are calculated by utilizing the processor.

Alternatively, in step B, a first, a second, a third, and a fourth positioning point are preferably positioned. Based on the four coordinates, maximum and minimum values of the respective x-coordinate and y-coordinate values are obtained. Additionally, the mean values of the maximum and minimum values of the x-coordinate and y-coordinate are calculated. These mean values are further used as the coordinates of the center point.

The present invention will be apparent after reading the detailed description of the preferred embodiment thereof in reference to the accompanying drawings.

### BRIEF DESCRIPTION OF THE DRAWINGS

FIG. 1 illustrates a flow chart of an automatic positioning/engraving method of the present invention.

FIG. 2 illustrates a schematic view showing step B and step C of the automatic positioning/engraving method in a first embodiment of the present invention;

FIG. 3 illustrates a schematic view showing a second embodiment of the present invention.

### DETAILED DESCRIPTION

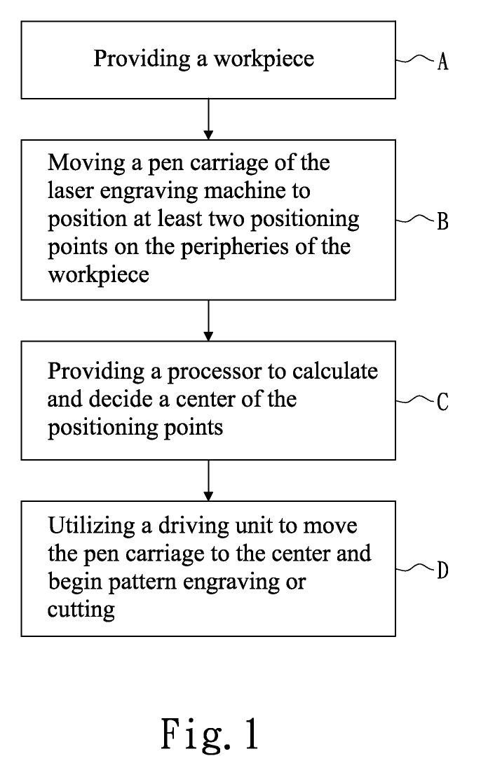

Please refer to FIG. 1 that shows a flow chart of an automatic positioning/engraving method according to the present invention. The automatic positioning/engraving method comprises following steps:

A. providing a workpiece;

B. moving a pen carriage of the laser engraving machine to position at least two positioning points on the peripheries of the workpiece;

C. providing a processor to calculate and decide a center of the positioning points; and

D. utilizing a driving unit to move the pen carriage to the center and to begin the pattern engraving or cutting operation.

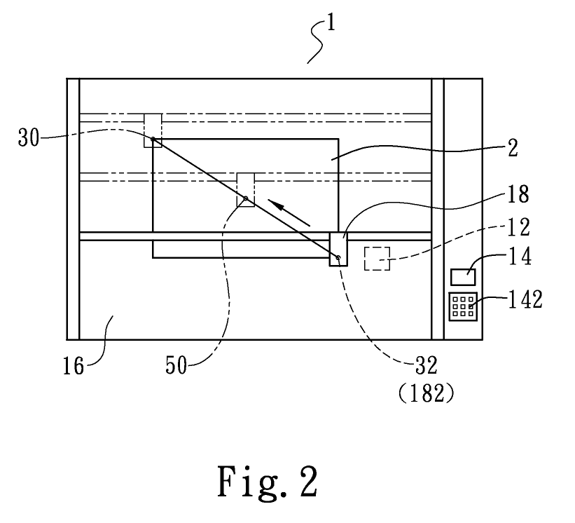

FIG. 2 shows a first preferred embodiment of the present invention. In this embodiment, a workpiece in rectangular shape is used as an example. According to the embodiment, a first positioning point and a second positioning point are positioned respectively. A center on the line aligning these two positioning points is then calculated by the processor. Preferably, the first and the second positioning points are two points on the peripheries of the workpiece having the longest distance than any other two points on the workpiece.

As shown in FIG. 2, a laser engraving machine 1 is provided on one lateral side thereon with a processor 12, a screen 14, and a keyboard 142. Besides, the laser machine 1 is provided with a platform 16 on which a pen carriage 18 is provided capable of moving transversely and longitudinally. The pen carriage 18 has an infrared emitter/receiver 182 therein. A workpiece 2 is a plain plate and is positioned on the platform 16 of the laser engraving machine 1.

In step B, the infrared emitter of the pen carriage 18 is used for positioning, the processor is used for reading the coordinate data fed back from a driving unit to decide the coordinates of the pen carriage 18, and a display screen is used to show the coordinates. As shown in FIG. 2, when the pen carriage 18 is moved above the workpiece 2, the infrared emitter of the pen carriage 18 emits infrared ray downwards. When the infrared receiver receives the reflected infrared ray, the information of the coordinates detected by the infrared ray is transmitted to the processor 12 and displayed on the screen 14 simultaneously. Accordingly, a first positioning point 30 is determined. In a similar way, a second positioning point 32 can be determined and displayed on the screen 14 when the pen carriage 18 is moved to the second positioning point 32.

In step C, the processor 12 is used to figure out a center 50 on the line aligning the first and the second positioning points 30, 32 according to the coordinates of the first and the second positioning points 30, 32. After obtaining the coordinates of the center 50, the processor 12 activates a servo motor that can move the pen carriage 18 longitudinally or transversely to move the pen carriage 18 to the center 50 that is used as a reference point for starting pattern engraving or cutting operation. Besides, the servo motor used for moving the pen carriage 18 longitudinally or transversely is served as the driving unit (not shown in FIG. 2).

In practice, the positioning method as described in step B, an infrared emitter can be utilized to emit infrared ray. When the emitter irradiates on the platform 16 and a storage key on the keyboard 142 is pressed, the processor 12 reads the data fed back from the driving unit to determine the coordinates of the pen carriage 18 and display the coordinates on the screen 14. By the method set forth above, the coordinates of the first and the second positioning points 30, 32 can be accurately obtained. After the calculation executed by the processor 12, the pen carriage 18 can be moved to the center 50 under the control of the driving unit to start pattern engraving or cutting operation.

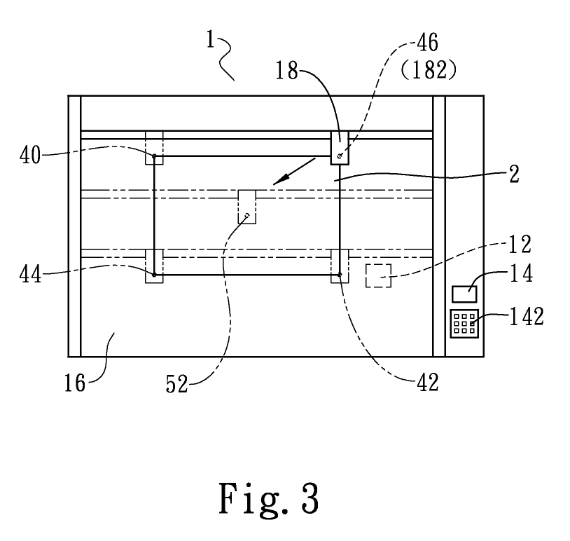

FIG. 3 shows a second preferred embodiment of the present invention. For better description, all features similar to those of the first preferred embodiment are omitted. In the second preferred embodiment, the workpiece 2″ is a rectangular, however, applicable to any irregular shape workpiece. In practice, a center 52 is determined after four positioning points, a first, a second, a third, and a fourth positioning point 40, 42, 44, 46, are positioned.

As shown in FIG. 3, when the four positioning points 40, 42, 44, 46 are determined, the maximum and minimum values of the x-coordinate and y-coordinate values are respectively determined based on the coordinates of the four positioning points 40, 42, 44, 46. Then, the mean values of the maximum and minimum values of the x-coordinate and y-coordinate values are calculated by the processor 12. The mean values serve as the center 52 of the four positioning points 40, 42, 44, 46. Finally, the pen carriage 18 is moved to the center 52 to start pattern engraving or cutting operation by the driving unit.

In conclusion, according to the above description, the present invention surely can accomplish the expected objects to provide an automatic positioning/engraving or cutting method for a laser carving machine. Adopting this method can save time for manual positioning, avoid errors resulted from any manual positioning, decide accurately the position for processing a pattern, and save material cost as well. It is new and can be put into industrial use.

Although the embodiments of the present invention have been described in details, various modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. An automatic positioning/engraving method for a laser engraving machine comprises:
providing a workpiece;
moving a pen carriage of the laser engraving machine above the workpiece;
positioning at least two positioning points on the peripheries of the workpiece;
providing a processor to calculate and decide a center of the positioning points; and
utilizing a driving unit to move the pen carriage to the center and begin pattern engraving or cutting.

2. The automatic positioning/engraving method for a laser engraving machine as claimed in claim 1, wherein at least a first positioning point and a second positioning point are positioned on the workpiece.

3. The automatic positioning/engraving method for a laser engraving machine as claimed in claim 2, wherein the first positioning point and the second positioning point are two points on the peripheries of the workpiece having the longest distance than any other two points on the workpiece.

4. The automatic positioning/engraving method for a laser engraving machine as claimed in claim 2, wherein the center is calculated based on the straight line distance between the first positioning point and the second positioning point.

5. The automatic positioning/engraving method for a laser engraving machine as claimed in claim 2, wherein an infrared emitter is first used to locate positioning points, the processor is then used to read data fed back from a driving unit to decide a coordinate position of the pen carriage and to show the coordinates of the pen carriage on a display screen.

6. The automatic positioning/engraving method for a laser engraving machine as claimed in claim 1, wherein a first positioning point, a second positioning point, a third positioning point, and a fourth position point are positioned on the workpiece.

7. The automatic positioning/engraving method for a laser engraving machine as claimed in claim 6 further comprises determining the maximum and minimum of the x-coordinate and y-coordinate values based on the coordinates of the four positioning points; and calculating the mean values of the maximum and minimum of the x-coordinate and y-coordinate values to be the coordinates of the center.

8. The automatic positioning/engraving method for a laser engraving machine as claimed in claim 6, wherein an infrared emitter is first used to locate positioning points, the processor is then used to read data fed back from a driving unit to decide a coordinate position of the pen carriage and to show the coordinates of the pen carriage on a display screen.
